(19) United States
(12) Patent Application Publication
(10) Pub. No.: US 2025/0153766 A1
(43) Pub. Date: May 15, 2025

(54) CONTROL DEVICE AND CONTROL METHOD OF ELECTRIC POWER STEERING SYSTEM, AND ELECTRIC POWER STEERING SYSTEM INCLUDING THE SAME

(71) Applicant: HL MANDO CORPORATION, Gyeonggi-do (KR)

(72) Inventors: Sumin LEE, Gyeonggi-do (KR); Kyuyeong JE, Gyeonggi-do (KR)

(21) Appl. No.: 18/916,677

(22) Filed: Oct. 15, 2024

(30) Foreign Application Priority Data
Nov. 9, 2023 (KR) 10-2023-0154451

(51) Int. Cl. B62D 5/04; B62D 6/00

(52) U.S. Cl. CPC B62D 5/046; B62D 5/0475; B62D 6/001

(57) ABSTRACT

The present embodiments relate to a control device and method for an electric power steering (EPS) system, and an EPS system including the same. A control device according to an embodiment may include a steering controller configured to control a rotation of a motor linked to a steering wheel, and a wake-up circuit configured to, in an ignition-off state of a vehicle, wake up the steering controller using back electromotive force generated in the case of a forced rotation of the motor by an external force, wherein the steering controller may apply a reaction torque to the motor to suppress the forced rotation of the motor after waking up.

### CROSS REFERENCE TO RELATED APPLICATION

This application claims priority from Korean Patent Application No. 10-2023-0154451, filed on Nov. 9, 2023, which is hereby incorporated by reference for all purposes as if fully set forth herein.

### TECHNICAL FIELD

An embodiment of the present disclosure relates to a control device and a control method of an electric power steering (EPS; may be abbreviated as “EPS” hereinafter) system, and an electric power steering system including the same. More specifically, the embodiments of the present disclosure relate to a control device and method capable of waking up an electronic control unit (ECU) by motor rotation in an EPS system of a steer-by-wire (SBW) type and suppressing rapid steering of the steering wheel.

### BACKGROUND

A steering device or a steering system is used as a device for controlling the travelling direction of a vehicle. Recently, there is widely utilized an electric power steering (EPS) system in which a steering motor provides necessary steering force by electronic control.

The EPS system or a EPS device may operate to rotate a steering shaft of a steering column or move a rack bar connected thereto by driving a steering motor according to a steering torque applied to a steering wheel by a driver.

As an example of such an EPS system, there is an SBW steering system that is an EPS system of a steer-by-wire (SBW) type.

The SBW steering system may include a structure that removes a mechanical coupling device such as a steering column, a universal joint, or a pinion shaft between a steering wheel and a wheel of a vehicle.

The SBW steering system may generally include an upper device and a lower device mechanically separated from each other, and a control circuit for controlling the upper device and the lower device.

In the case of the SBW steering system, since the upper device connected to a steering wheel and the lower device connected to a rack bar are mechanically separated, even if a reaction force motor or a steering motor is turned off due to a vehicle ignition-off, a steering wheel interlocked therewith may rotate or a wheel may be steered.

That is, even if the reaction force motor of the upper device is turned off due to the vehicle ignition-off, since the steering wheel and steering column are separated from the lower device, the steering wheel may rotate arbitrarily.

In addition, even if the steering motor of the lower device is turned off due to the vehicle ignition-off, the rack bar linked thereto may move left and right, and thus the wheels may be arbitrarily steered.

Accordingly, in the SBW steering system, there may be further required a locking device for forcibly locking the reaction force motor or the steering motor in the case of the vehicle ignition-off.

A locking device may be implemented as a part of the steering control circuit included in the SBW steering system, and may have a configuration in which a rotation of a three-phase motor is prevented by shorting the multi-phase windings of the steering motor to the same potential in the case of a condition requiring motor restraint.

That is, in a locking condition such as a case of vehicle ignition-off, the locking circuit may operate to prevent rotation of the reaction motor or steering motor, thereby preventing rotation of the steering wheel.

In the case of using such a locking circuit, there is a disadvantage that power consumption occurs since the locking circuit is required to operate even when the vehicle ignition is off and a power source therefor is required.

In addition, a control device of the EPS may be complicated since a separate locking circuit is required to be provided.

Therefore, there is required a simple and low-power device to restrain the rotation of a steering wheel of an EPS in the case of the vehicle ignition-off.

### SUMMARY

In this background, embodiments of the present disclosure is to provide a control device and method of an EPS system capable of restraining the rotation of the steering wheel under conditions when the vehicle's ignition is off in the electric steering system of a vehicle, and an electric power steering system including the same.

Embodiments of the present disclosure is to provide a control device and method of an EPS system capable of, in the state of the vehicle ignition-off, restricting the rotation of the steering wheel using the back electromotive force generated due to a forced rotation of a motor included in the electric steering and an electric power steering system including the same.

Embodiments of the present disclosure is to provide a control device and method of an EPS system capable of, in the state of the vehicle ignition-off, waking up an electronic control unit using the back electromotive force generated by a forced rotation of the motor included in the electric steering system and controlling the electronic control unit to provide reaction force to the motor to restrain the rotation of the steering wheel, and an electric power steering system including the same.

In accordance with an aspect of the present disclosure, there may be provided a control device of an electric power steering system including a steering controller configured to control a rotation of a motor linked to a steering wheel, and a wake-up circuit configured to, in an ignition-off state of a vehicle, wake up the steering controller using back electromotive force generated in the case of a forced rotation of the motor by an external force, wherein the steering controller is configured to apply a reaction torque to the motor to suppress the forced rotation of the motor after waking up.

The steering controller may, after waking up, determine a non-driving state of the vehicle based on vehicle status information received from a sensor, and apply the reaction torque to the motor only in the case of the non-driving state.

In this case, the vehicle status information may include at least one of vehicle ignition information, vehicle speed information, vehicle door lock information, vehicle door open information, driver boarding information, seat belt fastening information, and theft alarm function activation information.

In addition, the steering controller may include a regulator configured to regulate a voltage from a power supply, an inverter configured to supply control current to windings included in the motor, a gate driver configured to control an operation of the inverter, and a micro-control unit (MCU) configured to be driven by a driving voltage supplied from the regulator and control an operation of the gate driver.

In addition, the wake-up circuit may include a rectifier circuit configured to rectify the back electromotive force and output a direct current output voltage, and a switching circuit configured to enable the regulator according to the output voltage of the rectifier circuit.

The rectifier circuit may rectify a sinusoidal back electromotive force generated during the forced rotation of the motor into a direct current voltage and output the output voltage.

In addition, the switching circuit may include a first switching unit which is turned on according to the output voltage, and a second switching unit which turns on if the first switching unit is turned on and inputs a wake-up signal by the voltage of the power supply to an enable terminal of the regulator.

Meanwhile, the electric power steering system may be a steer-by-wire steering system which comprises an upper device including a reaction motor linked to the steering wheel, and a lower device mechanically separate from the upper device and including a steering driving motor linked to a wheel of the vehicle. In this case, the motor linked to the steering wheel may be the reaction motor included in the upper device.

In this case, the reaction torque may be a torque for rotating the reaction motor in a direction opposite to a direction of the forced rotation of the reaction motor.

The steering controller may, after waking up, provide the reaction torque to the motor for a specific holding time and then may be turned off or enter a sleep mode, and the holding time may be set to a period of 2 to 5 seconds.

In accordance with another aspect of the present disclosure, there may be provided a control method of an electric power steering system including waking up, by a wake-up circuit, a steering controller using back electromotive force generated in the case of a forced rotation of a motor linked to a steering wheel by an external force, and generating and applying, by the steering controller woke up, a reaction torque to the motor to suppress the forced rotation of the motor.

In this case, the waking up may include rectifying a sinusoidal back electromotive force generated during the forced rotation of the motor into a direct current voltage and outputting an output voltage, and inputting, by a switching circuit turned-on by the output voltage, a wake-up signal by a voltage of a power supply to an enable terminal of a regulator included in the steering controller.

The control method of an electric power steering system may further include determining a non-driving state of a vehicle based on vehicle status information received from a sensor. In this case, the generating and applying may include applying the reaction torque to the motor only in the case of the non-driving state of the vehicle.

In addition, the generating and applying may include providing the reaction torque to the motor for a specific holding time and then turning off or entering a sleep mode.

In accordance with another aspect of the present disclosure, there may be provided an electric power steering system including a motor linked to a steering wheel of a vehicle, a steering controller configured to control rotation of the motor, and a wake-up circuit configured to, in an ignition-off state of a vehicle, wake up the steering controller using back electromotive force generated in the case of a forced rotation of the motor by an external force, wherein the steering controller is configured to apply a reaction torque to the motor to suppress the forced rotation of the motor after waking up.

In this case, the electric power steering system may be a steer-by-wire steering system which includes an upper device including a reaction motor linked to the steering wheel, and a lower device mechanically separate from the upper device and including a steering driving motor linked to a wheel of the vehicle, and the motor linked to the steering wheel may be the reaction motor included in the upper device.

According to an embodiment of the present disclosure, it is possible to restrict the rotation of the steering wheel under a condition of the vehicle ignition-off.

In addition, according to an embodiment of the present disclosure, it is possible to, in the vehicle ignition-off state, prevent the rotation of the steering wheel using the back electromotive force generated by a forced rotation of a motor included in the electric steering system.

In addition, according to an embodiment of the present disclosure, it is possible to, in the vehicle ignition-off state, wake up an electronic control unit using the back electromotive force generated by a forced rotation of a motor included in the electric steering system, and control the electronic control unit to provide a reaction force to the motor to constrain the rotation of the steering wheel.

Therefore, according to embodiments of the present disclosure, it is possible to prevent the random rotation of the steering wheel in a vehicle ignition-off state, thereby preventing vehicle theft and maintaining vehicle stability.

### BRIEF DESCRIPTION OF THE DRAWINGS

FIG. 1 illustrates an example of a schematic configuration of an electric power steering system.

FIG. 2 illustrates a schematic configuration of a SBW steering system to which the embodiments can be applied.

FIG. 3 illustrates a functional block diagram of a steering control device according to an embodiment.

FIG. 4 illustrates an example of the detailed configuration of a steering control device according to an embodiment.

FIG. 5 illustrates the detailed configuration of a rectifier circuit included in a wake-up circuit according to an embodiment.

FIG. 6 illustrates an example of a waveform of back electromotive force generated by forced rotation of a motor.

FIG. 7 illustrates an example of a waveform of a DC output voltage generated by rectifying back electromotive force by a rectifier circuit.

FIG. 8 illustrates an example of the detailed configuration of the switching circuit included in the wake-up circuit according to an embodiment.

FIG. 9 illustrates a flowchart of a control method of an electric steering system according to an embodiment of the present disclosure.

FIG. 10 illustrates the configuration of an SBW steering system, which is an example of an electric steering system according to an embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

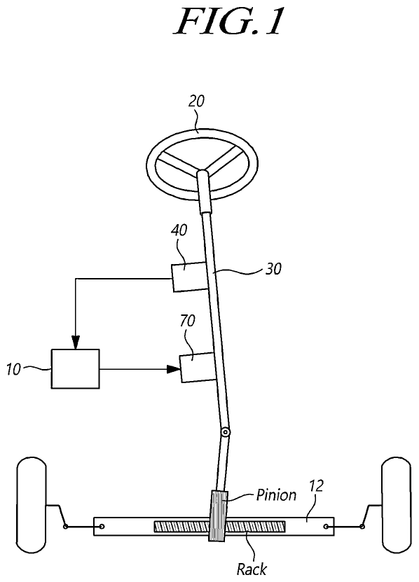

FIG. 1 illustrates an example of a schematic configuration of an electric power steering system.

A steering device or steering system may be used as a device for controlling the driving direction of a vehicle, and recently, there is widely used an electric power steering (EPS) system in which a steering motor provides necessary steering force by electronic control.

An EPS system or EPS device may operate to rotate a steering column or move a rack bar connected thereto by driving an EPS steering motor according to a steering torque applied to a steering wheel by a driver.

An EPS system in which a steering motor rotates a steering column may be expressed as a column-type EPS system or a C-type EPS system. In the C-type EPS system, a steering column may be connected with a universal joint and a pinion gear, and the pinion gear may be coupled with a rack gear of a rack bar connected to a wheel of a vehicle.

FIG. 1 illustrates a C-type EPS system, and the C-type EPS system may include a steering column 30 connected to a steering wheel 20, a sensor unit 40 installed on the steering column, a steering motor 70 for rotating a steering column, and an electronic control unit (ECU) 10 as a steering controller or steering control circuit for controlling the steering motor. A specific reducer may be connected to the steering motor, and the reducer may be interlocked between the steering column and the steering motor.

The steering column 30 may be coupled to the steering wheel 20 and may be rotated together with the steering wheel 20. The shape of the steering column 30 may be cylindrical.

Although not shown, the steering column 30 may be interlocked with one or more reducers, and any one of a plurality of reducers may be coupled to an outer circumferential surface of the steering column 30.

The sensor unit 40 may include a steering angle sensor, a torque sensor, and a vehicle speed sensor.

The steering angle sensor may detect a steering angle generated by rotation of the steering wheel 20. In addition, the steering angle sensor 40 may output a steering angle signal indicating information on the steering angle.

The torque sensor may detect steering torque generated by rotation of the steering wheel 20. In addition, if the steering torque is detected, the torque sensor may output a steering torque signal indicating information on the steering torque.

Here, the steering torque may mean rotational torque acting on a torsion bar existing between an input shaft and an output shaft of the steering column 30. Therefore, steering torque may be detected even if the steering wheel 20 is not rotating.

The vehicle speed sensor may detect a speed of a vehicle and output a vehicle speed signal indicating information on the vehicle speed.

The steering controller or ECU 10 may receive steering information, calculate a target rack position for providing a steering assist force based on the steering information, and output a command current corresponding to the rack position to the steering motor 70. Here, the steering information may include one or more of a steering angle signal output by a steering angle sensor, a steering torque signal output by a torque sensor, and a vehicle speed signal output by a speed sensor.

The ECU 10 may be implemented with hardware and software including a micro controller unit (MCU), an inverter, a printed circuit board (PCB), and the like.

The steering motor 70 may receive a command current from the ECU 10 and be driven at torque and rotational speed according to the command current. Although not shown, the steering motor 70 may be coupled with a reducer disposed on the steering column 30. Rotation of the steering motor 70 may rotate the reducer interlocked with the steering column 30 and the steering column.

Meanwhile, the steering column may be rotated by the rotation of the steering motor 70, and accordingly, the rack bar linked to the pinion gear at the output end of the steering column may move left and right.

Accordingly, the vehicle may be steered by moving wheels connected to both ends of the rack bar to the left or right.

The steering motor 70 included in the C-type EPS system may be a three-phase motor, but is not limited thereto.

The ECU 10 may perform a function of receiving power from a power supply unit (not shown), generating a target current to be supplied to each winding of the steering motor using an inverter, and supplying the target current to the steering motor.

In the C-type EPS system, when the steering motor 70 rotates the steering column 30 to apply steering assist force, the steering assist force may be transmitted to the rack bar 12 through the pinion-rack gear. As the rack bar moves left and right, the wheels connected thereto may be steered left and right.

Meanwhile, an EPS system in which a steering motor directly moves a rack bar connected to a wheel may be referred as a rack-type EPS system or an R-type EPS system.

In the R-type EPS system, the steering motor and the rack bar may be connected by a belt or gear, and a reducer such as a ball nut is linked therebetween. As the steering motor rotates, the ball nut reducer linked to the rack bar rotates, and the rack bar may move left and right according to the rotation of the reducer to steer the wheels.

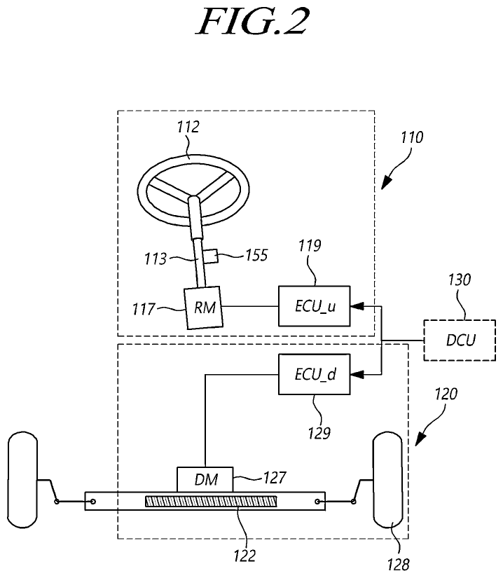

FIG. 2 illustrates a schematic configuration of a SBW steering system to which the embodiments can be applied.

As an example of the EPS system, there is an SBW steering system that is an EPS system of a steer-by-wire (SBW) type.

The SBW steering system may include a structure in which the mechanical coupling devices such as a steering column, a universal joint, or a pinion shaft between a steering wheel and a wheel are removed.

Referring to FIG. 2, the SBW steering system to which an embodiment of the present disclosure can be applied may include an upper device 110 and a lower device 120 that are mechanically separated from each other, and a control device 130 for controlling the upper device 110 and a lower device 120.

The upper device 110 may include a steering wheel 112, a steering column 113 connected to the steering wheel, a torque sensor 155 for detecting torque applied to the steering wheel, a reaction force motor 117 as a motor device for providing reaction force torque to the steering wheel according to steering through a lower rack bar, and an upper ECU 119 for controlling the reaction force motor. This upper device 110 may be referred as a steering feedback actuator (SFA).

In addition, the lower device 120 may include a rack bar 122 connected to a wheel 128 of a vehicle, a steering driving motor 127 for moving the rack bar left and right, and a lower ECU 129 for controlling the steering driving motor.

The lower ECU 129 of the lower device 120 may generate a steering assist torque signal proportional to the steering torque applied to the steering wheel, and generate a driving signal for moving a rack bar connected to a tie rod of a wheel to the left and right by using a steering assist torque signal.

The lower device 120 may control the steering driving motor through a ball nut reducer based on the driving signal. The lower device may be referred as a road wheel actuator (RWA).

That is, in the SBW steering system, the upper device including a steering wheel, a steering column and a reaction force motor and the lower device including a rack bar driving device (i.e., a pinion gear, a ball nut and a steering driving motor) may operate independently without intermediate mechanical connection.

Therefore, in order to provide a driver with steering feeling, there is required to rotate the steering wheel connected to the upper device according to the movement of the rack bar of the lower device where actual steering is performed. In this case, the force or torque applied to the steering wheel may be defined as reaction force or reaction force torque.

Meanwhile, the steering system is required to not operate when the engine of the vehicle is turned off or in the case of the vehicle ignition-off.

That is, if the steering wheel is rotated in a state in which the vehicle engine is turned off or the vehicle ignition is off to allow the wheels to rotate, there may occur a problem in which the wheels of a stopped or parked vehicle are arbitrarily steered.

Accordingly, if the steering wheel rotates in a state of the vehicle ignition-off, the vehicle can be steered, which may make vehicle theft easier and reduce the stability of the parked vehicle.

Therefore, the steering wheel is required to be locked when the engine of the vehicle is turned off or in the case of the vehicle ignition-off.

Meanwhile, in the C-type EPS system or R-type EPS system, even if the steering motor is turned off due to the vehicle ignition-off, the steering wheel may be automatically locked since the mechanical structures such as a steering column, a rack bar, and a reducer are interlocked between the steering wheel and the wheel.

However, in the case of the SBW steering system, the upper device connected to the steering wheel and the lower device connected to the rack bar are mechanically separated. Therefore, even if the reaction force motor or steering motor is turned off due to the vehicle ignition-off, the steering wheel linked to the upper device may rotate or a vehicle wheel linked to the lower device may be steered.

That is, even if the reaction force motor of the upper device is turned off due to the vehicle ignition-off, since the steering wheel and steering column are separated from the lower device, the steering wheel may rotate arbitrarily.

In addition, even if the steering motor of the lower device is turned off due to the vehicle ignition-off, the rack bar linked thereto can move left and right, so that the vehicle wheels may be arbitrarily steered.

That is, unlike the C-type EPS system or R-type EPS system, in the case of the SBW steering system, it is necessary to separately implement a locking function that restricts the rotation of the steering wheel or the movement of the rack bar in the case of the vehicle ignition-off.

Accordingly, the SBW steering system is required to have a locking device forcibly locking the reaction force motor or the steering motor in the case of the vehicle ignition-off.

As an example of such a locking device, a separate clutch device may be provided to mechanically connect the upper device and the lower device.

As another example of the locking device, there may be provided a key lock solenoid device for locking the steering column in the case of the vehicle ignition-off.

As another example of a locking device, there may be used a locking device including a locking circuit for limiting the motor rotation. In this case, power may be supplied to the locking circuit regardless of the vehicle ignition-off, and the locking circuit may prevent the motor from rotating by short-circuiting the windings of the motor.

In general, a motor used in a steering system may be a three-phase motor including u-phase, v-phase, and w-phase and corresponding u-phase coils, v-phase coils, and w-phase coils.

In the case of such a three-phase motor, if an input terminal of each phase coil is floating, the three-phase motor may rotate arbitrarily.

Therefore, in the case of the vehicle ignition-off, the input terminal of the three-phase steering motor included in the EPS system, particularly the SBW steering motor, may be floated, and the steering motor rotates arbitrarily accordingly, resulting in problems with vehicle stability.

Therefore, there may be provided a locking circuit capable of preventing motor rotation by shorting an input terminal to a three-phase coil of a reaction force motor or steering motor included in the SBW steering system to the same potential in the case of the vehicle ignition-off.

Meanwhile, an EPS system including the SBW steering system may include a steering control circuit for controlling a steering motor.

Specifically, in order to drive/control the steering motor, a SBW steering controller may include a power supply unit and a steering control circuit to supply driving current to the steering motor.

The steering control circuit may also be expressed as a steering controller, a steering ECU, and the like.

In general, the steering control circuit included in the EPS system may include an inverter composed of a plurality of switching devices or switching elements, and an inverter driving circuit or a gate driving circuit for controlling the inverter.

In particular, the steering control circuit included in the SBW steering system may include, in addition to the inverter and the inverter driving circuit (or gate driving circuit), a locking circuit for preventing rotation of the steering motor or reaction force motor in the case of the vehicle ignition-off, as described above.

Such a locking circuit may be turned on by a locking signal provided from the steering controller in the state of the vehicle ignition-off, and may prevent rotation of the motor by short-circuiting the multi-phase winding of the reaction motor or steering motor.

The locking circuit is required to operate when the vehicle ignition is off, and therefore there may have the disadvantage that power for operating the locking circuit is consumed even if the vehicle ignition is off.

In addition, since a separate locking circuit ire required to be provided, the steering control device of the electric steering system may be complicated.

Therefore, hereinafter, there is proposed a steering control device which is simple and can operate with low power consumption to restrict the rotation of the EPS steering wheel in the case of the vehicle ignition-off.

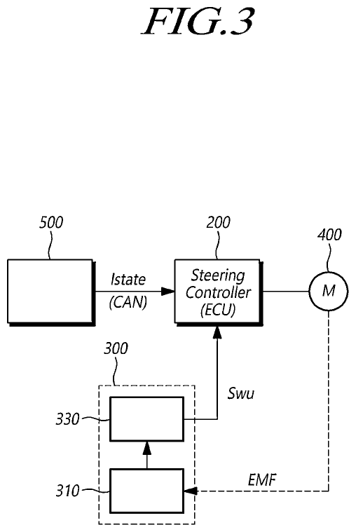

FIG. 3 illustrates a functional block diagram of a steering control device according to an embodiment.

Referring to FIG. 3, a steering control device according to an embodiment may include a steering controller 200 which controls the rotation of a motor 400 linked to a steering wheel, and a wake-up circuit 300 which wakes up the steering controller using back electromotive force.

The wake-up circuit 300 may wake up the steering controller using back electromotive force generated when the motor is forced to rotate by an external force in a vehicle ignition-off state.

More specifically, the wake-up circuit 300 may include a rectifier circuit 310 for rectifying the three-phase back electromotive force (EMF) voltage of a sinusoidal wave and outputting a direct current (DC) voltage above a specific threshold, and a switching circuit 330 which is turned on using an output signal from the rectifier circuit to wake up the steering controller.

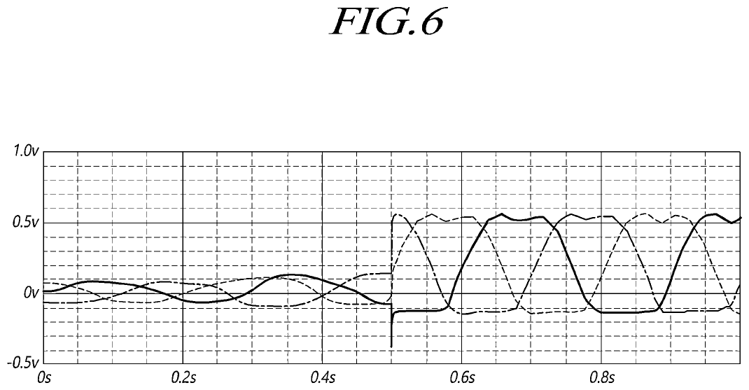

An example of the detailed configuration of this wake-up circuit 300 is described in more detail below with reference to FIG. 6.

Additionally, the steering controller 200 may determine a non-driving state of a vehicle based on the vehicle status information I_state received from a sensor 500 after waking up.

In this case, the steering controller 200 may apply the reaction torque to the motor 400 only if it is determined that the vehicle is in the non-driving state.

In this case, the vehicle status information may include at least one of vehicle ignition information, vehicle speed information, vehicle door lock information, vehicle door open information, driver boarding information, seat belt fastening information, and theft alarm function activation information.

Accordingly, the sensor 500 may include a vehicle ignition detection sensor, a vehicle speed sensor, a vehicle door sensor, a weight detection sensor or image sensor for detecting driver boarding, a seat belt fastening detection sensor, a theft alarm detection sensor, and so on.

The vehicle status information may be transmitted to the steering controller 200 through a vehicle controller area network (CAN) communication network connected to each sensor.

Specifically, the steering controller 200 may determine that the vehicle is in a non-driving state if at least one conditions among a condition in which vehicle ignition information indicates an ignition-off state, a condition in which vehicle speed information indicates a vehicle stopped state, and vehicle door lock information indicates a door lock locked state, a condition in which the vehicle door open information indicates that one or more of the vehicle doors are open, a condition in which the driver boarding information indicates that the driver or passenger is not inside the vehicle, a condition in which the seat belt fastening information indicates that the seat belt is not fastened, a condition indicating the theft alarm function activation information indicates the activation status of the vehicle anti-theft device inside the vehicle is satisfied.

As an example, after waking up, the steering controller 200 may generate reaction torque and apply the reaction torque to the motor only when the vehicle ignition is off and the vehicle is in the non-driving state.

As another example, the steering controller, which wakes up in the vehicle ignition-off state, may apply the reaction torque to the motor if the vehicle status information indicates that the vehicle is in the non-driving state, even if the vehicle is in a vehicle ignition-on state thereafter, thereby preventing the rotation of the steering wheel.

This is because that, for example, in the case that steering controller wakes up by a forced rotation of the steering wheel, it is required to limit the rotation of the steering wheel if the vehicle is in an abnormal driving state, such as a vehicle stopped state, a vehicle door open state, a vehicle door-lock locked state, an occupant absent state, a seat belt non-fasten state, an activation state of a vehicle anti-theft device, even if the vehicle is in a vehicle ignition-on state thereafter due to an attempt by an unqualified person to start the vehicle or an attempt to start the vehicle remotely.

In addition, according to an embodiment, the determination of the vehicle non-driving state and the application of reaction force torque may be performed only for a specific time period after the steering controller wakes up.

This is because, if the steering controller is woken up by forced rotation of the steering wheel, there is no need to determine the non-driving state and apply the reaction force torque after entering the normal vehicle ignition-on state and starting normal driving of the vehicle.

For example, if a legitimate driver forcibly rotates the steering wheel before turning on the vehicle ignition, there is no need to apply reaction torque even if the steering controller is woken up according to the embodiment, so it is possible to determine the non-driving state of the vehicle and apply reaction torque only for a specific threshold time period.

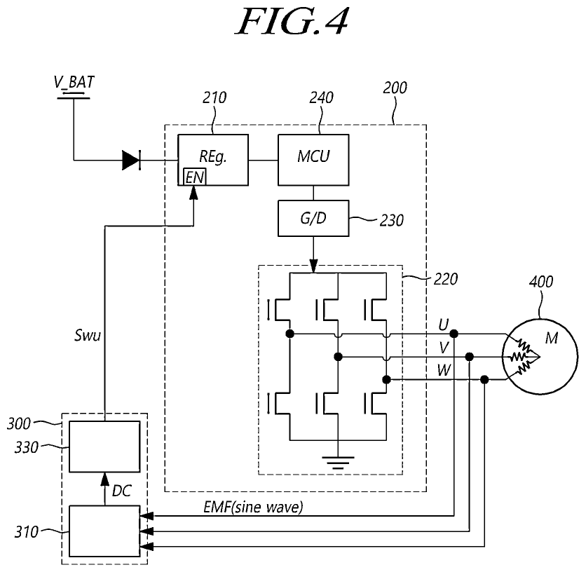

Meanwhile, the steering controller 200 according to the embodiment may include a regulator, an inverter, a gate driver, and a micro-control unit (MCU). A detailed configuration of the steering controller 200 is described in more detail below with reference to FIG. 4.

The electric power steering system including the steering control device according to the embodiment may be a general electric steering system, for example, a C-type EPS system, an R-type EPS system, etc. In this case, the motor may be a steering motor for rotating the steering column or rack bar to steer the wheels of the vehicle.

Alternatively, the steering control device according to the embodiment may be applied to a steer-by-wire (SBW) steering system.

In particular, the steering control device according to the embodiment may be applied to an upper device constituting the SBW steering system. In this case, the motor may be a reaction motor included in the upper device of the SBW steering system.

For example, the electric steering system according to an embodiment may be a steer-by-wire steering system including an upper device which includes a reaction motor linked to the steering wheel, and a lower device which is mechanically separated from the upper device and includes a steering driving motor linked to the wheel of the vehicle. In this case, the motor linked to the steering wheel may be the reaction motor included in the upper device.

In this case, the reaction torque may be a torque for rotating the reaction motor in a direction opposite to the forced rotation direction of the reaction motor.

More specifically, the SBW steering system including the steering control device according to an embodiment may, as shown in FIG. 2, include an upper device 110 and a lower device 120 that are mechanically separated from each other, and a control device 130 for controlling the upper device and the lower device. The control device 130 may be expressed as a domain control unit (DCU).

Specifically, the upper device 110 may include a steering wheel 112, a steering column 113 connected to the steering wheel, a torque sensor 115 for detecting torque applied to the steering wheel, a reaction motor 117 as a motor device to provide reaction torque to the steering wheel according to steering through the rack bar, and an upper ECU 119 for controlling the reaction motor.

In addition, the lower device 120 may include a rack bar 127 connected to a wheel 128, a steering driving motor 127 for moving the rack bar left and right, and a lower ECU 129.

The lower ECU 129 of the lower device 120 may generate a steering assistance torque signal proportional to the steering torque applied to the steering wheel, and use the steering assistance torque signal to generate a driving signal to move the rack bar connected to the tie-rod of the wheel left and right.

In particular, the steering control device according to the embodiment may be applied to the upper device 110 that constitutes the SBW steering system as shown in FIG. 2.

In this case, the motor 400 may be a reaction motor 117 included in the upper device 110 of the SBW steering system, and the steering controller 200 may be an upper ECU 119 included in the upper device 110 of the SBW steering system.

That is, the motor 400 and the steering controller 200 included in the steering control device shown in FIG. 3 may be the reaction motor 117 and the upper ECU 119 included in the upper device 110 of the SBW steering system shown in FIG. 2, respectively.

The present disclosure is not limited to this, and the control device according to an embodiment may be applied to the lower device 120 of the SBW steering system.

In this case, the motor 400 included in the steering control device shown in FIG. 3 may be the steering driving motor 127 included in the lower device 120 of the SBW steering system shown in FIG. 2.

In this case, the upper ECU 119 or the lower ECU 129 may be woken up by the back electromotive force generated when the steering driving motor 127 is forced to rotate.

The woken-up upper ECU 119 or lower ECU 129 may provide reaction torque to suppress forced rotation to the reaction motor 117 or the steering driving motor 127.

In the case of a parked vehicle in the vehicle ignition-off state, the wheels may be steered due to abnormal changes in the parking space (parking tower, etc.) or a vehicle theft attempt.

In this case, the steering driving motor 127 linked to the wheel may be forced to rotate, and accordingly, back electromotive force may be generated in the winding of the steering driving motor 127.

Therefore, in the same manner as described above, the upper ECU 119 of the upper device or the lower ECU 129 of the lower device may be woke-up by using the back electromotive force generated in the winding of the steering driving motor 127.

In the case that the steering wheel is forcibly rotated by an external force, a back electromotive force may be generated in the reaction motor 117 of the upper device 110, and in the case that the wheel is forcibly steered by an external force, the back electromotive force may be generated at the steering driving motor 127 of the lower device 120.

Therefore, the control device according to an embodiment may wake up the upper ECU 119 or the lower ECU 129 using the back electromotive force generated from one of the reaction force motor 117 or the steering driving motor 127 of the SBW steering system, and may provide the reaction torque for suppressing forced rotation to the reaction motor 117 or the steering driving motor 127.

For example, if there is a great need to suppress the rotation of the steering wheel in a vehicle ignition-off state, the control device may wake up the upper ECU 119 using the back electromotive force generated from the reaction motor 117 or the steering driving motor 127 of the SBW steering system, and provide reaction torque which suppresses forced rotation to the reaction motor 117 linked to the steering wheel.

Alternatively, if there is a greater need to suppress random steering of the wheels in the vehicle ignition-off state, the control device may wake up the lower ECU 129 using the back electromotive force generated from the reaction motor 117 or the steering driving motor 127 of the SBW steering system, and provide the reaction torque for suppressing forced rotation to the steering driving motor 127 linked to the wheel.

Meanwhile, the steering controller 200 may include a regulator, an inverter, a gate driver and a micro-control unit, and the wake-up circuit 300 according to the embodiment may use the back electromotive force generated by forced rotation of the motor to wake up the steering controller 200 by turning on the regulator included in the steering controller 200.

An example of the detailed configuration of the steering controller 200 will be described in more detail below with reference to FIG. 4.

Meanwhile, the reaction torque applied by the wake-up steering controller 200 to the motor 400 may be a torque which rotates the reaction motor in a direction opposite to the forced rotation direction of the motor 400.

That is, the steering controller 200, which is woken up by the forced rotation of the motor in the vehicle ignition-off state, may determines the reaction torque for suppressing the forced rotation of the motor, generate a command current corresponding to the reaction torque, and supply the command current to the windings of the motor.

The magnitude of the reaction torque may be proportional to the rotation torque caused by forced rotation of the motor, and the direction of the reaction torque may be opposite to the direction of the rotation torque caused by forced rotation of the motor. For example, the magnitude of the reaction torque may be determined to be proportional to the magnitude of the back electromotive force generated by forced rotation of the steering wheel.

As a result, it is possible to suppress the rotation of the steering wheel due to external force in the vehicle ignition-off state.

Additionally, the steering controller may be turned off or may enter a sleep mode after providing the reaction torque to the motor for a specific holding time after being woken up.

In this case, the holding time may be set to a time period of 2 to 5 seconds.

The holding time may also be expressed as a latch-off delay time.

In order to provide the holding time, the steering controller 200 may include a separate latch-off circuit or delay circuit.

By using the holding time, it is possible to further ensure stability by providing reaction torque to the motor and preventing rotation of the steering wheel only for a specific period of time, even if the back electromotive force disappears after the steering controller wakes up.

FIG. 4 illustrates an example of the detailed configuration of a steering control device according to an embodiment.

The steering control device according to an embodiment may include a steering controller 200 for controlling the rotation of a motor 400 linked to a steering wheel, and a wake-up circuit 300 for waking up the steering controller 200 using the back electromotive force generated by a forced rotation of the motor due to an external force in the vehicle ignition-off state. In this case, the steering controller 200 may apply a reaction torque to the motor to suppress forced rotation of the motor after waking up.

Referring to FIG. 4, the steering controller 200 included in the steering control device according to an embodiment may be expressed as an ECU, and may include a regulation 210, an inverter 220, a gate driver 230, and a micro-control unit (MCU) 240.

The regulator 210 may receive a battery voltage V_BAT from a vehicle power supply, regulate the battery voltage to output a driving voltage for driving the MCU 440.

The regulator 210 may include an enable terminal EN through which an enable signal for enabling the regulator is input.

The inverter 220 may perform the function of supplying control current to the winding included in the motor 400.

The inverter 220 may convert the battery voltage V_BAT of a battery as a vehicle power supply, which is direct current (DC) or a driving voltage of the direct current output from the regulator 210 into alternating current (AC), and may apply the converted alternating current voltage (or alternating current) to the motor 400.

As an example, in the case that the motor is a reaction motor (117 in FIG. 2) included in the upper device of the SBW steering system and the vehicle is in a driving state, the inverter 220 may apply a driving current capable of providing a reaction torque to be applied to the steering wheel to the motor 400 in order to rotate the steering wheel in response to steering of the wheel by the lower device.

The inverter may be controlled by the gate driver 230, which will be described below, and the gate driver 230 may be controlled by the MCU 240.

Meanwhile, the motor 400 controlled by the steering control device according to an embodiment of the present disclosure may be a three-phase motor having u, v, and w phases.

In this case, as shown in FIG. 4, the inverter 220 may include a H-bridge circuit for supplying u-phase driving current, v-phase driving current, and w-phase driving current to the three-phase windings (u, v, w windings) of the motor 400, respectively.

The gate driver 230 may control the driving of the inverter 220.

Specifically, the gate driver 230 may input control signals to a gate terminals of the u, v, and w circuit switches included in the inverter 220 so as to control the inverter 220 to supply the u-phase driving current, the v-phase driving current and the w-phase driving current to the motor 400.

The MCU 240 may control the operation of the gate driver 230 with the driving voltage supplied from the regulator 210.

Specifically, the MCU 240 may generate a gate driver enable signal to activate the gate driver 230 and supply the gate driver enable signal to the gate driver 230.

As a result, in a normal driving state of a vehicle, the MCU 240 may generate a control signal capable of generating a reaction torque corresponding to wheel steering by the lower device of the SBW steering system and transmit the control signal to the gate driver 230. The gate driver 230 may control the inverter 220 to supply the driving current for the reaction torque corresponding to the control signal to the motor 400.

Meanwhile, if the vehicle ignition is off, the battery voltage V_BAT may not be supplied to the regulator 210, so the steering controller 200 is turned off.

In this case, the three-phase winding of the motor 400 may be in a floating state, and thus the rotor of the motor 400 may rotate freely by external force. Accordingly, the steering wheel linked to the motor 400 may also rotate freely, which may deteriorate vehicle stability.

Therefore, the steering control device according to the embodiment of the present disclosure may wake up the steering controller 200 in the vehicle ignition-off state and apply a reaction torque to the motor to suppress rotation of the motor due to external force, thereby preventing the rotation of the steering wheel.

Specifically, the wake-up circuit 300 may wake up the steering controller 200, which is in an off state or sleep state, by using the back electromotive force generated when the motor is forced to rotate by an external force.

The awakened steering controller 200 may apply a reaction torque for suppressing forced rotation of the motor to the motor.

Hereinafter, there will be described the wake-up circuit 300 and the wake-up operation of the steering controller using the wake-up circuit.

Referring to FIG. 4, the wake-up circuit 300 may include a rectifier circuit 310 which rectifies the back electromotive force, and a switching circuit 330 which generates and outputs a wake-up signal Swu to wake up the steering controller 200 according to the output voltage of the rectifier circuit.

As an example, the switching circuit 330 may be turned on by the direct current output voltage output from the rectifier circuit 310 and generate a wake-up signal Swu for enabling the regulator 210 included in the steering controller 200 and input the wake-up signal Swu to the enable terminal EN of the regulator 210.

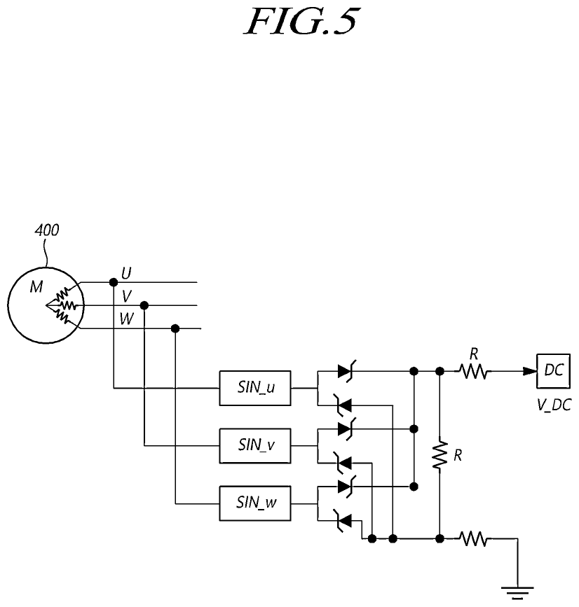

An example of the detailed configuration of the wake-up circuit 300 will be described in more detail below with reference to FIGS. 5 to 8.

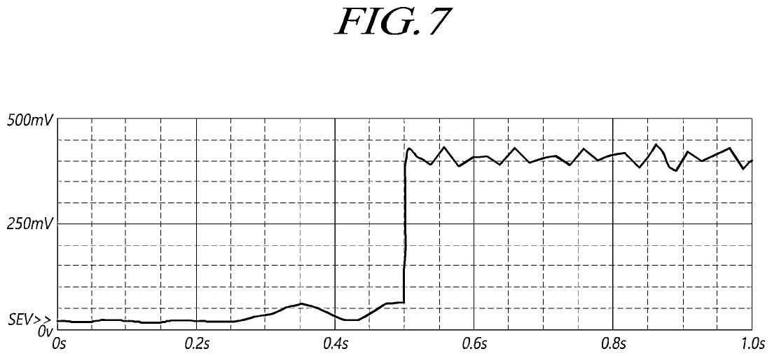

FIG. 5 illustrates the detailed configuration of a rectifier circuit included in a wake-up circuit according to an embodiment, FIG. 6 illustrates an example of a waveform of back electromotive force generated by forced rotation of a motor, and FIG. 7 illustrates an example of a waveform of a DC output voltage generated by rectifying back electromotive force by a rectifier circuit.

Referring to FIG. 5, the rectifier circuit 310 included in the wake-up circuit according to the embodiment may be connected to the three-phase winding of the motor, and may receive sinusoidal back electromotive force signals SIN_u, SIN-v and SIN_w generated by forced rotation of the motor from each winding.

The rectifier circuit 310 may include two diodes corresponding to each phase and a plurality of resistance elements in order to rectify the sinusoidal back electromotive force signals of each phase SIN_u, SIN_v and SIN_w.

Referring to FIG. 5, each of the sinusoidal back electromotive force signals SIN_u, SIN_v and SIN_w generated in each phase of the motor may be rectified by a rectifier circuit element including two diodes to produce an output signal DC, which is a direct current voltage V_DC.

Hereinafter, it will be described a case in which forced rotation of the motor occurs due to an external force 0.5 seconds after the ignition is turned off, as an example.

Referring to FIG. 6, in a state where there is no forced rotation of the motor, a back electromotive force close to 0 is generated. After the forced rotation of the motor due to an external force occurs (approximately 0.5 second time point), the sinusoidal back electromotive force signal SIN_u, SIN_v and SIN_w with an amplitude of approximately 0.6V and a period of approximately 0.2 seconds may be generated from the windings of each phase of the motor.

If the sinusoidal back electromotive force signals SIN_u, SIN_v, and SIN_w generated in each phase winding are rectified in the rectifier circuit as shown in FIG. 5, there is generated a direct current (DC) voltage V_DC with a voltage of a specific threshold voltage of 0.4V or more as shown in FIG. 7.

In this case, the amplitude and period of the sinusoidal back electromotive force signal generated from each phase winding may vary depending on the rotation speed of forced rotation of the motor, change in angular speed, or rotation torque.

In addition, the magnitude of the DC voltage V_DC rectified by the rectifier circuit 310, that is, the magnitude of the output signal DC), may also vary depending on the rotation speed of forced motor rotation, a change in angular speed or rotation torque, and the resistance value of the resistance element.

However, the magnitude of the DC voltage V_DC rectified by the rectifier circuit 310, that is, the potential difference of the output signal DC of the rectifier circuit 310 may be greater than the threshold voltage capable of turning on the first switching unit TR1 of the switching circuit 330, which will be described below.

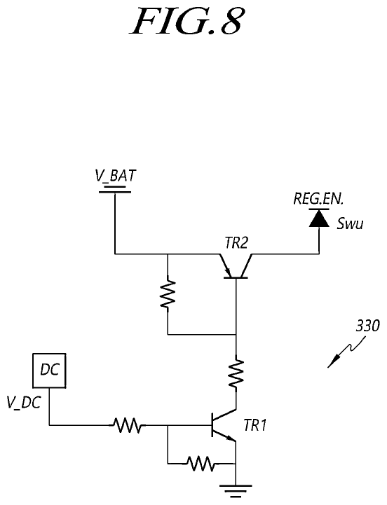

FIG. 8 illustrates an example of the detailed configuration of the switching circuit included in the wake-up circuit according to an embodiment.

Referring to FIG. 8, the switching circuit 330 included in the wake-up circuit according to the embodiment may include a first switching unit TR1 which is turned on according to the output voltage DC of the rectifier circuit 310, a second switching unit TR2 which is turned on in response to the turn-on of the first switching unit, and a plurality of resistance elements.

The second switching unit TR2 may be turned on when the first switching unit TR1 is turned on, and input the wake-up signal Swu by the voltage V_BAT of the power supply to the steering controller 200 to wake up the steering controller 200.

Specifically, the second switching unit TR2 may transmit a wake-up signal Swu corresponding to the battery voltage V_BAT, which is the voltage of the power supply unit, to the enable terminal EN of the regulator 210 included in the steering controller 200.

Additionally, the first switching unit TR1 and the second switching unit TR2 may be a transistor or FET having a gate terminal, a source terminal, and a drain terminal, but are not limited thereto.

As an example, the gate terminal of the first switching unit TR1 included in the switching circuit 330 may be connected to the output terminal of the rectifier circuit 310 to receive the output signal DC of the rectifier circuit 310.

The second switching unit TR2 may be connected to the first switching unit TR1, and may be turned on when the first switching unit TR1 is turned on.

As an example, as shown in FIG. 8, the source terminal of the second switching unit TR2 may be connected to the battery voltage V_BAT of the power supply unit, and the drain terminal of the second switching unit TR2 may be connected to the enable terminal of the regulator 210 included in the steering controller 200.

In addition, the drain terminal of the first switching unit TR1 may be connected to the gate terminal of the second switching unit TR2, and the source terminal of the first switching unit TR1 may be grounded.

In this switching unit 330, if a back electromotive force is generated due to forced rotation of the motor, the output signal DC of the rectifier circuit 310 above a specific threshold voltage may be input to the gate terminal of the first switching unit TR1.

In this case, the threshold voltage may be a gate-source threshold voltage capable of turning on the first switching unit TR1.

If the voltage of the output signal DC of the rectifier circuit 310 is less than the threshold voltage of the first switching unit TR1, there may be further provided a separate boosting circuit for boosting the output signal DC to be higher than the threshold voltage. For example, a boosting circuit (not shown) may be disposed between the rectifier circuit 310 and the first switching unit TR1, and may boost the voltage of the output signal DC from the rectifier circuit 310 to more than the gate-source threshold voltage of the first switching unit TR1.

In this case, the output signal of the rectifier circuit 310 may be input to the boosting circuit, and the output signal of the boosting circuit may be input to the gate terminal of the first switching unit TR1 of the switching circuit 330.

Accordingly, the first switching unit TR1 may be turned on, and a voltage signal above a specific level may be also applied to the gate terminal of the second switching unit TR2.

The second switching unit TR2 may be also turned on, and the battery voltage V_BAT of the power supply unit may be input to the enable terminal of the regulator 210 connected to the drain terminal of the second switching unit TR2.

If the regulator 210 is enabled, as shown in FIG. 4, the driving voltage rectified from the regulator may be applied to the MCU 240 to wake up the steering controller 200.

After waking up, the steering controller 200 may determine the non-driving state of the vehicle based on vehicle state information I_state received from a sensor.

In this case, the steering controller 200 may apply a reaction torque opposing the external force which causes forced rotation of the motor to the motor only when it is determined that the vehicle is in a non-driving state.

As a result, it is possible to prevent the steering wheel from rotating arbitrarily even if forced rotation of the motor is attempted by an external force in the vehicle ignition-off state.

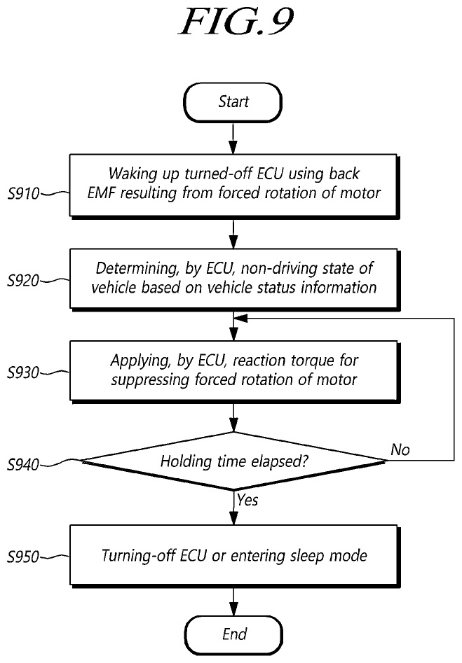

FIG. 9 illustrates a flowchart of a control method of an electric steering system according to an embodiment of the present disclosure.

Referring to FIG. 9, a control method of the electric steering system according to an embodiment may include a step S910 in which the wake-up circuit wakes up the steering controller using the back electromotive force generated when the motor linked to the steering wheel is forced to rotate by an external force, and a step S930 in which the awakened steering controller generates a reaction torque for suppressing forced rotation of the motor and applies the reaction torque to the motor.

In addition, the control method of the electric steering system according to an embodiment may further include a step S920 in which the awakened steering controller determines a non-driving state of the vehicle based on vehicle status information received from the sensor.

In this case, if it is determined in step S920 that the vehicle is in the non-driving state, there may be performed a step S930 of applying the reaction torque to the motor.

The vehicle status information may be one or more of vehicle ignition n information, vehicle speed information, vehicle door lock information, vehicle door open information, driver boarding information, seat belt fastening information, and theft alarm function activation information.

The wake-up circuit for performing the step S910 of waking up the steering controller may include a rectifier circuit which rectifies the back electromotive force and a switching circuit which enables the regulator according to the output voltage of the rectifier circuit.

As an example, in the step S910 of waking up the steering controller, the rectifier circuit included in the wake-up circuit may rectify the sinusoidal back electromotive force generated during forced rotation of the motor to a direct current DC voltage to output an output voltage.

In addition, the step S910 of waking up the steering controller may include a step in which the switching circuit turned on by the output voltage inputs a wake-up signal by the voltage of the power supply to the enable terminal of the regulator included in the steering controller.

For this purpose, the switching circuit may include a first switching unit which is turned on according to the output voltage, and a second switching unit which is turned on in response to the turn-on of the first switching unit and inputs a wake-up signal based on the voltage of the power supply to the enable terminal of the regulator.

In addition, in the step S930 of applying a reaction torque to the motor, the wake-up steering controller may provide the reaction torque to the motor for a specific holding time and then turn off or enter a sleep mode (S940, S950).

In this case, the holding time may be expressed as a latch-off delay time, and may be set to a time period of about 2 to 5 seconds.

Meanwhile, the electric steering system to which the method according to this embodiment is applied may be an SBW steering system.

That is, the electric steering system or the electric power steering system may include an upper device including a reaction motor linked to the steering wheel, and a lower device mechanically separated from the upper device and including a steering driving motor linked to the wheel. The motor linked to the steering wheel may be the reaction motor included in the upper device.

Meanwhile, according to an embodiment of the present disclosure, there may provide an electric steering system including a motor linked to the steering wheel of a vehicle, a steering controller for controlling rotation of the motor, and a wake-up circuit which wakes up the steering controller by back electromotive force generated in the case of a forced rotation of the motor by an external force in the vehicle ignition-off state.

In this case, the steering controller may apply a reaction torque to the motor to suppress forced rotation of the motor after waking up.

Since the specific configuration of the steering controller and wake-up circuit included in the electric steering system may correspond to the configuration of the control device of the electric steering system described above, there is omitted description to avoid duplication.

However, the electric steering system to which embodiments of the present disclosure are applied may be an SBW steering system including an upper device including a reaction motor linked to the steering wheel, and a lower device which is mechanically separated from the upper device and includes a steering driving motor linked to the wheel, which will be described in more detail below.

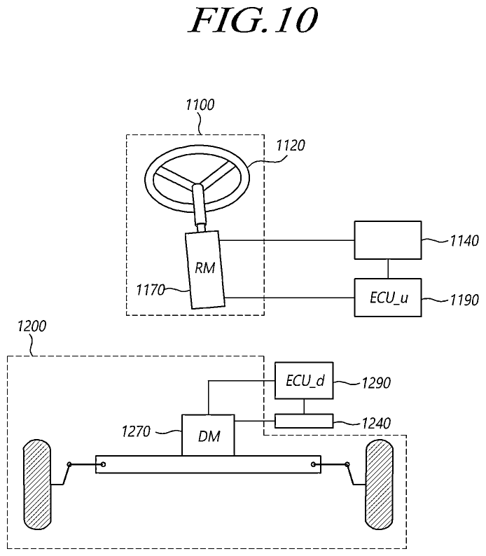

FIG. 10 illustrates the configuration of an SBW steering system, which is an example of an electric steering system according to an embodiment of the present disclosure.

Referring to FIG. 10, the electric steering system according to an embodiment may be a steer-by-wire steering system including an upper device 1100 which includes a reaction motor 1170 linked to a steering wheel 1120, and a lower device 1200 which is mechanically separated from the upper device and includes a steering driving motor 1270 linked to the wheel of the vehicle.

The detailed configuration of the upper device 1100 and the lower device 1200 may correspond to the configuration described in FIG. 2.

The reaction motor 1170 of the upper device 1100 may provide a steering reaction torque to the steering wheel according to the steering of the wheel by the lower device 1200. The steering reaction torque is used to rotate the steering wheel so as for the driver to feel the degree of steering of the wheels.

The upper device 1100 may include an upper ECU 1190 for controlling the reaction motor 1170, and the upper ECU may be a steering controller according to the embodiment of the present disclosure.

A wake-up circuit 1140 may be connected to the upper ECU 1190.

The wake-up circuit 1140 may wake up the upper ECU 1190 by using the back electromotive force generated when the reaction motor 1170 is forced to rotate by an external force when the vehicle is in an ignition-off state.

The upper ECU 1190 may prevent forced rotation of the steering wheel by applying a reaction torque for suppressing forced rotation of the reaction motor 1170 to the motor after waking up.

The wake-up circuit 1140 may include a rectifier circuit and a switching circuit, as described in FIGS. 5 to 8.

The upper ECU 1190 may include, as the steering controller 200 shown in FIG. 4, a regulator for regulating the voltage from the power supply and an inverter for supplying control current to the winding included in the reaction motor 1170, a gate driver for controlling the operation of the inverter, and a micro-control unit (MCU) for controlling the operation of the gate driver with a driving voltage supplied from the regulator.

In addition, the wake-up circuit 1140 may include a rectifier circuit which rectifies the back electromotive voltage generated by forced rotation of the reaction motor and outputs a direct current output voltage, and a switching circuit which enables the regulator according to the output voltage of the rectifier circuit.

The rectifier circuit of the wake-up circuit 1140 may rectify the sinusoidal back electromotive voltage generated during forced rotation of the reaction motor 1170 into a direct current DC voltage to output the output voltage.

In addition, the switching circuit of the wake-up circuit 1140 may include a first switching unit which is turned on according to the output voltage, and a second switching unit which is turned on when the first switching unit is turned on and inputs a wake-up signal based on the driving voltage of the power supply to the enable terminal of the regulator.

In addition, the upper ECU 1190 may, after being woken up by the wake-up circuit 1140, determine the non-driving state of the vehicle based on vehicle status information received from the sensor, and may apply the reaction torque to the reaction force motor 1170 only in the non-driving state of the vehicle.

In this case, the vehicle status information may be one or more of vehicle ignition information, vehicle speed information, vehicle door lock information, vehicle door open information, driver boarding information, seat belt fastening information, and theft alarm function activation information.

After waking up, the upper ECU 1190 may provide the reaction torque to the reaction force motor 1170 for a specific holding time, and then may be turned off or enter a sleep mode.

In the above, it has been described an example in which the embodiment is applied to the upper device of the SBW steering system, but the present disclosure is not limited thereto.

As an example, the control device according to an embodiment may be applied to the lower device 1200 or both the upper device 1100 and the lower device 1200 of the SBW steering system shown in FIG. 10.

The lower device 1200 may further include a wake-up circuit 1240 connected to a lower ECU 1290.

In this case, the upper ECU 1190 or the lower ECU 1290 may be woken up by the back electromotive force generated when the steering driving motor 1270 is forced to rotate.

The woken up upper ECU 1190 or lower ECU 1290 may provide reaction torque to suppress forced rotation to the reaction motor 1170 or the steering driving motor 1270.

In the case that the vehicle ignition is off, the steering wheel may be forcibly rotated or the wheels may be forcibly steered by an external force.

In this case, the reaction motor 1170 linked to the steering wheel or the steering driving motor 1270 linked to the wheel may be forced to rotate, and accordingly, there may be generated the back electromotive force in the winding of the reaction motor 1170 or the steering driving motor 1270.

Therefore, in the same manner as described above, the wake-up circuit 1140 of the upper device or the wake-up circuit 1240 of the lower device may wake up the upper ECU 1190 of the upper device or the lower ECU 1290 of the lower device by using the back electromotive force generated in the winding of the reaction motor 1170 or the steering driving motor 1270.

That is, in the case that the steering wheel is forcibly rotated by an external force, a back electromotive force may be generated in the reaction motor 1170 of the upper device 1100, and in the case that the wheel is forcibly steered by an external force, the back electromotive force may be generated in the steering driving motor 1270 of the lower device 1200.

Therefore, the control device according to an embodiment may wake up the upper ECU 1190 or lower ECU 1290 using the back electromotive force generated from the reaction motor 1170 or the steering driving motor 1270 of the SBW steering system, and may provide reaction torque to suppress forced rotation to the reaction motor 1170 or the steering driving motor 1270.

For example, if there is a greater need to suppress the rotation of the steering wheel in the vehicle ignition-off state, the control device may wake up the upper ECU 1190 using the back electromotive force generated from the reaction motor 1170 or the steering driving motor 1270 of the SBW steering system, and may provide reaction torque for suppressing the forced rotation to the reaction motor 1170 linked to the steering wheel.

Alternatively, if there is a greater need to suppress steering of the wheels in the vehicle ignition-off state, the control device may wake up the lower ECU 1290 using the back electromotive force generated from the reaction motor 1170 or the steering driving motor 1270 of the SBW steering system, and may provide reaction torque for suppressing the forced rotation to the steering driving motor 1270 linked to the vehicle wheel.

As described above, the embodiment of the present disclosure may be applied to the SBW steering system and may selectively prevent forced rotation of the steering wheel by external force or forced steering of the wheel by external force.

In addition, according to embodiments of the present disclosure, it is possible to suppress the rotation of the steering wheel or arbitrary steering of the wheels by using back electromotive force generated by the forced rotation of the motor included in the electric steering system in a vehicle ignition-off state.

In addition, according to embodiments of the present disclosure, it is possible to wake up the electronic controller using the back electromotive force generated when the motor included in the electric steering system is forced to rotate and provide the reaction force to the motor by the electronic control unit, thereby suppressing the rotation of the steering wheel or preventing arbitrary steering of the wheels.

Accordingly, according to embodiments of the present disclosure, it is possible to prevent theft of a vehicle in the ignition-off state and maintain the stability of the vehicle while using a simple device with low power consumption.

It should be noted that although all or some of the configurations or elements included in one or more of the embodiments described above have been combined to constitute a single configuration or component or operated in combination, the present disclosure is not necessarily limited thereto. That is, within the scope of the object or spirit of the present disclosure, all or some of the configurations or elements included in the one or more of the embodiments may be combined to constitute one or more configurations or components or operated in such combined configuration(s) or component(s). Further, each of the configurations or elements included in one or more of the embodiments may be implemented by an independent hardware configuration; however, some or all of the configurations or elements may be selectively combined and implemented by one or more computer program(s) having one or more program module(s) that perform some or all functions from one or more combined hardware configuration(s). Codes or code segments constituting the computer program(s) may be easily produced by those skilled in the art. As the computer programs stored in computer-readable media are read and executed by a computer, embodiments of the present disclosure can be implemented. The media for storing computer programs may include, for example, a magnetic storing medium, an optical recording medium, and a carrier wave medium.

Further, unless otherwise specified herein, terms ‘include’, ‘comprise’, ‘constitute’, ‘have’, and the like described herein mean that one or more other configurations or elements may be further included in a corresponding configuration or element. Unless otherwise defined herein, all the terms used herein including technical and scientific terms have the same meaning as those understood by those skilled in the art. The terms generally used such as those defined in dictionaries should be construed as being the same as the meanings in the context of the related art and should not be construed as being ideal or excessively formal meanings, unless otherwise defined herein.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A device for controlling an electric power steering system, the device comprising:
a steering controller configured to control a motor operably connected to a steering wheel; and
a wake-up circuit configured to, in an ignition-off state of a vehicle, wake up the steering controller using back electromotive force generated by rotation of the motor caused by an external force,
wherein the steering controller is configured to, after being woken up, control to apply a reaction torque to the motor to suppress the rotation of the motor caused by the external force.

2. The device of claim 1, wherein the steering controller is configured to, after being woken up, determine whether the vehicle is a non-driving state based on vehicle status information received from a sensor, and control to apply the reaction torque to the motor only when the vehicle is in the non-driving state.

3. The device of claim 2, wherein the vehicle status information comprises at least one of vehicle ignition information, vehicle speed information, vehicle door lock information, vehicle door open information, driver boarding information, seat belt fastening information, or theft alarm function activation information.

4. The device of claim 1, wherein the steering controller comprises:
a regulator configured to regulate a voltage from a power supply;
an inverter configured to supply control current to windings of the motor;
a gate driver configured to control the inverter; and
a micro-control unit (MCU) configured to be driven by a driving voltage supplied from the regulator and control the gate driver.

5. The device of claim 4, wherein the wake-up circuit comprises:
a rectifier circuit configured to rectify the back electromotive force and output a direct current (DC) output voltage; and
a switch circuit configured to enable the regulator according to the DC output voltage of the rectifier circuit.

6. The device of claim 5, wherein the rectifier circuit is configured to rectify a sinusoidal back electromotive force generated during the rotation of the motor caused by the external force into a DC voltage to output the output DC voltage.

7. The device of claim 5, wherein the switch circuit comprises a first switch unit configured to be turned on in response to the DC output voltage, and a second switch unit configured to be turned on in response to turning on the first switching unit and input a wake-up signal by the voltage of the power supply to an enable terminal of the regulator.

8. The device of claim 1, wherein:
the motor is a reaction motor connected to the steering wheel, and
the electric power steering system includes a steer-by-wire steering system which comprises an upper device including the reaction motor connected to the steering wheel, and a lower device not mechanically connected to the upper device and including a steering driving motor connected to a wheel of the vehicle.

9. The device of claim 1, wherein the reaction torque is a torque for rotating the motor in a direction opposite to a direction of the rotation of the motor caused by the external force.

10. The device of claim 1, wherein the steering controller configured to, after being woken up, control to provide the reaction torque to the motor for a holding time and then turn off or enter a sleep mode after the holding time.

11. The device of claim 10, wherein the holding time is set to a time period of 2 to 5 seconds.

12. A method for controlling an electric power steering system, the method comprising:
waking up, by a wake-up circuit, a steering controller using back electromotive force generated by rotation of a motor caused by an external force, the motor operably connected to a steering wheel; and
after the steering controller is woken by the wake-up circuit, controlling, by the steering controller, to apply a reaction torque to the motor to suppress the rotation of the motor caused by the external force.

13. The method of claim 12, further comprising, after the steering controller is woken by the wake-up circuit, determining whether a vehicle is in a non-driving state based on vehicle status information received from a sensor,
wherein the controlling to apply the reaction torque to the motor is performed only when the vehicle is in the non-driving state.

14. The method of claim 13, wherein the vehicle status information comprises at least one of vehicle ignition information, vehicle speed information, vehicle door lock information, vehicle door open information, driver boarding information, seat belt fastening information, or theft alarm function activation information.

15. The method of claim 12, wherein the waking up of the steering controller comprises:
rectifying a sinusoidal back electromotive force generated during the rotation of the motor caused by the external force into a direct current voltage to output an output voltage; and
after a switch circuit is turned on, inputting, by the switch circuit, a wake-up signal by a voltage of a power supply to an enable terminal of a regulator included in the steering controller.

16. An electric power steering system comprising:
a motor operably connected to a steering wheel of a vehicle;
a steering controller configured to control rotation of the motor; and
a wake-up circuit configured to, in an ignition-off state of a vehicle, wake up the steering controller using back electromotive force generated by rotation of the motor caused by an external force,
wherein the steering controller is configured to, after being woken up, control to apply a reaction torque to the motor to suppress the rotation of the motor caused by the external force.

17. The electric power steering system of claim 16, wherein the steering controller is configured to, after being woken up, determine whether the vehicle is in a non-driving state based on vehicle status information received from a sensor, and control to apply the reaction torque to the motor only when the vehicle is in the non-driving state,
wherein the vehicle status information comprises at least one of vehicle ignition information, vehicle speed information, vehicle door lock information, vehicle door open information, driver boarding information, seat belt fastening information, or theft alarm function activation information.

18. The electric power steering system of claim 16, wherein:
the motor is a reaction motor connected to the steering wheel, and
the electric power steering system includes a steer-by-wire steering system which comprises an upper device including the reaction motor connected to the steering wheel, and a lower device not mechanically connected to the upper device and including a steering driving motor connected to a wheel of the vehicle.

19. The electric power steering system of claim 18, wherein the steering controller comprises:
a regulator configured to regulate a voltage from a power supply;
an inverter configured to supply control current to windings of the reaction motor;
a gate driver configured to control the inverter; and
a micro-control unit (MCU) configured to be driven by a driving voltage supplied from the regulator and control the gate driver.

20. The electric power steering system of claim 19, wherein the wake-up circuit comprises:
a rectifier circuit configured to rectify the back electromotive force and output a direct current (DC) output voltage; and
a switch circuit configured to enable the regulator according to the DC output voltage of the rectifier circuit,
wherein the switch circuit comprises a first switch unit configured to be turned on in response to the DC output voltage, and a second switch unit configured to be turned on in response to turning on the first switch unit and input a wake-up signal by the voltage of the power supply to an enable terminal of the regulator.
